(19) United States
(12) Patent Application Publication
(10) Pub. No.: US 2013/0151018 A1
(43) Pub. Date: Jun. 13, 2013

(54) HEATING, VENTILATION AND AIR CONDITIONING SYSTEM USER INTERFACE HAVING REMOTE PLATFORM ACCESS APPLICATION ASSOCIATED THEREWITH AND METHOD OF OPERATION THEREOF

(71) Applicants: Larry S. Bias, Prosper, TX (US); Daniel Castillo, Plano, TX (US); Bobby DiFulgentiz, Frisco, TX (US); Gabaza B. Mlambo, McKinney, TX (US); Stephen J. Vendt, Little Elm, TX (US)

(72) Inventors: Larry S. Bias, Prosper, TX (US); Daniel Castillo, Plano, TX (US); Bobby DiFulgentiz, Frisco, TX (US); Gabaza B. Mlambo, McKinney, TX (US); Stephen J. Vendt, Little Elm, TX (US)

(73) Assignee: Lennox Industries Inc., Richardson, TX (US)

(21) Appl. No.: 13/432,766

(22) Filed: Mar. 28, 2012

Related U.S. Application Data
(60) Provisional application No. 61/569,859, filed on Dec. 13, 2011.

(51) Int. Cl. G05D 23/00

(52) U.S. Cl. 700/276

(57) ABSTRACT

An HVAC system and a method of communicating with an HVAC system. In one embodiment, the HVAC system includes: (1) a user interface having a touchpad configured to accept input from a user and a display configured to provide information to the user via a plurality of screens arranged in a screen structure, (2) an application executable on a general-purpose computer and configured to cause the general-purpose computer to display substantially similar counterparts of the screens arranged in the screen structure and (3) a receiver configured to communicate with the general-purpose computer.

### CROSS-REFERENCE TO RELATED APPLICATION

This application claims the benefit of U.S. Provisional Application Ser. No. 61/569,859, filed by Bias, et al., on Dec. 13, 2011, entitled “Heating, Ventilation and Air Conditioning System User Interface Having One or More of One-Touch Away Feature, Adjustable Fonts, Proportional Animation Graphics, Service Reminders on a Single Screen, Separate Programming and Manual Mode Screens, Integrated Screen/Housing Skin, Low-Profile Housing, Secure Functional Upgrade Feature and Remote Platform Access Application Associated Therewith,” commonly assigned with this application and incorporated herein by reference.

### TECHNICAL FIELD

This application is directed, in general, to a heating, ventilation and air conditioning (HVAC) systems and, more specifically, to an HVAC system having a user interface, such as a thermostat.

### BACKGROUND

Users interact with HVAC systems through user interfaces. The most common user interface employed today is the thermostat. The most basic thermostats feature one or more dials, switches or levers and allow users to set temperatures. More elaborate thermostats feature a liquid crystal display (LCD) screen, perhaps even of the touchscreen variety, and allow users to program their HVAC systems for automatic temperature settings, configure and maintain their HVAC systems and records of historical operation data, allowing the users to gauge the performance and efficiency of their HVAC systems.

Thermostats necessarily include both temperature sensors and control circuitry within their housings. Some user interfaces do not qualify as thermostats, because while they communicate with temperature sensors and control circuitry, they do not include both within their housings.

### SUMMARY

One aspect provides an HVAC system. In one embodiment, the HVAC system includes: (1) a user interface having a touchpad configured to accept input from a user and a display configured to provide information to the user via a plurality of screens arranged in a screen structure, (2) an application executable on a general-purpose computer and configured to cause the general-purpose computer to display substantially similar counterparts of the screens arranged in the screen structure and (3) a receiver configured to communicate with the general-purpose computer.

Another aspect provides a method of communicating with an HVAC system. In one embodiment, the method includes: (1) accepting input from a user with a user interface having a touchpad, (2) providing information to the user via a plurality of screens arranged in a screen structure using a display of the user interface, (3) executing an application in a general-purpose computer to cause the general-purpose computer to display substantially similar counterparts of the screens arranged in the screen structure and (4) using a receiver to communicate with the general-purpose computer.

Another aspect provides an HVAC system. In one embodiment, the HVAC system includes: ((1) a heat pump or a compressor having at least one stage, (2) at least one condenser coil, (3) an expansion valve, (4) at least one evaporator coil, (5) a loop of pipe interconnecting the heat pump or compressor, the at least one condenser coil, the expansion valve and the at least one evaporator coil and containing a refrigerant, (6) at least one fan configured to cause outdoor air and indoor air to blow over the at least one condenser coil and the least one evaporator coil, (7) a user interface having a touchpad configured to accept input from a user and a display configured to provide information to the user via a plurality of screens arranged in a screen structure, (8) an application executable on a general-purpose computer and configured to cause the general-purpose computer to display substantially similar counterparts of the screens arranged in the screen structure and (9) a receiver configured to communicate with the general-purpose computer.

### BRIEF DESCRIPTION

Reference is now made to the following descriptions taken in conjunction with the accompanying drawings, in which:

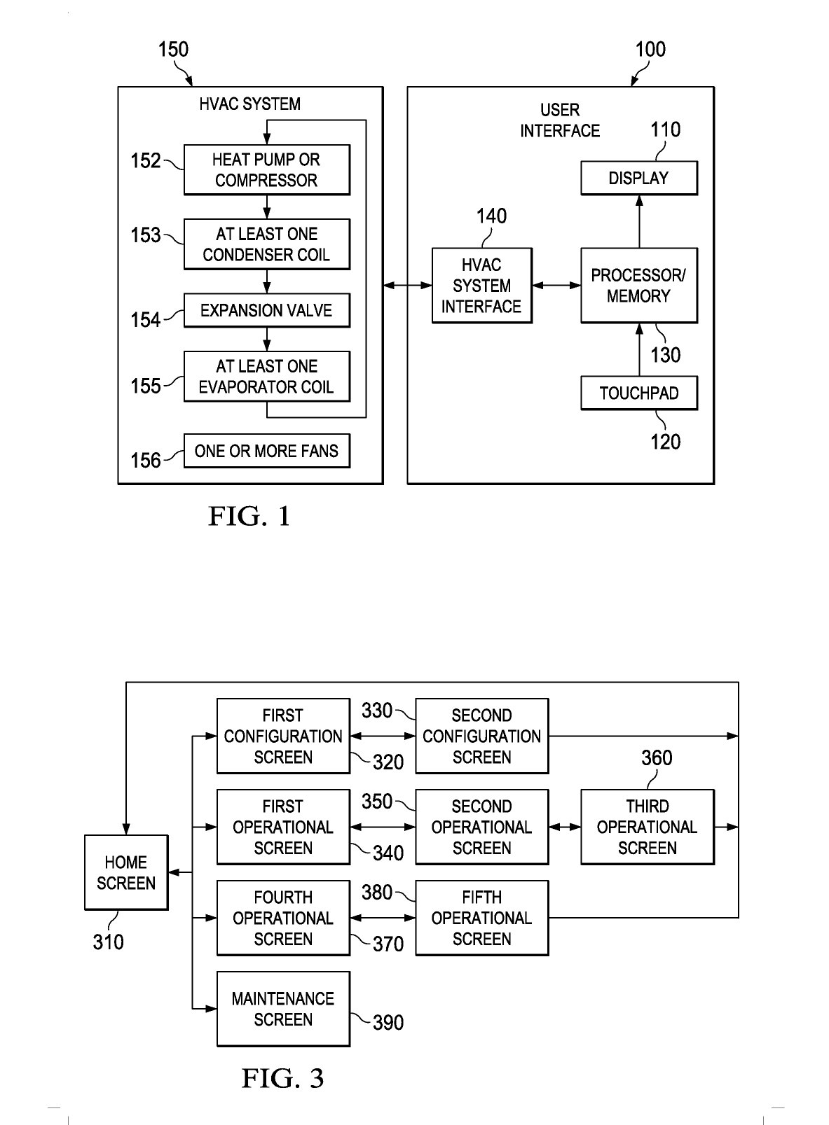

FIG. 1 is a block diagram of one embodiment of a user interface;

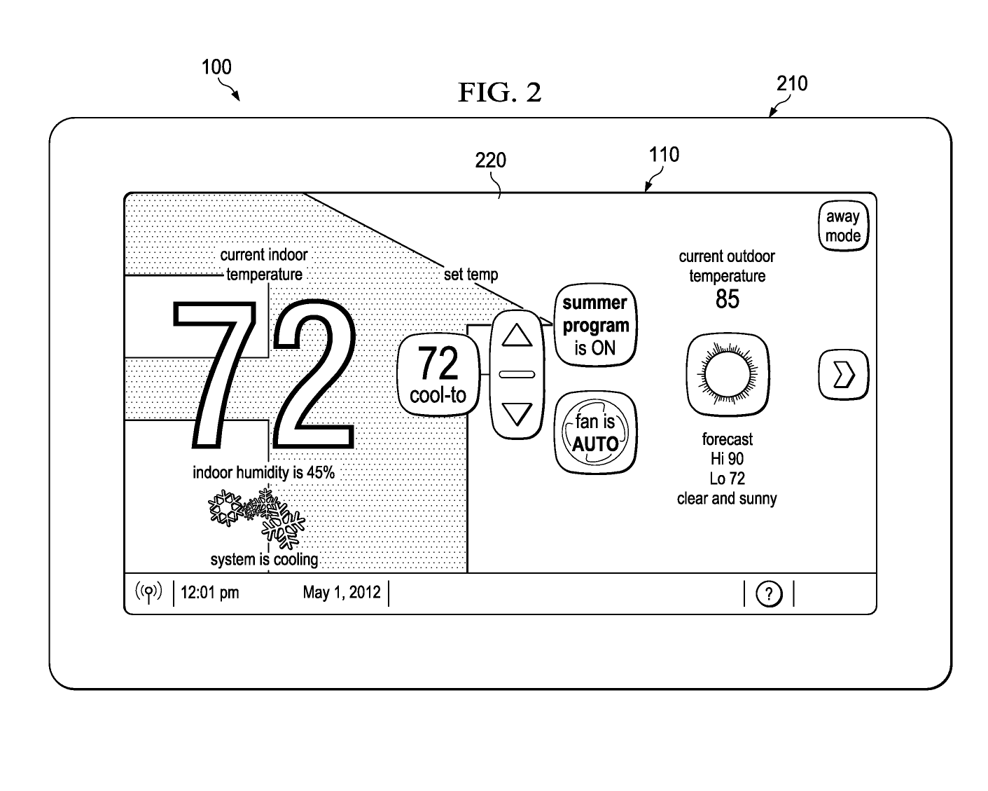

FIG. 2 is a front-side elevational view of one embodiment of a user interface;

FIG. 3 is a block diagram of one example of screens and a screen structure interrelating the screens;

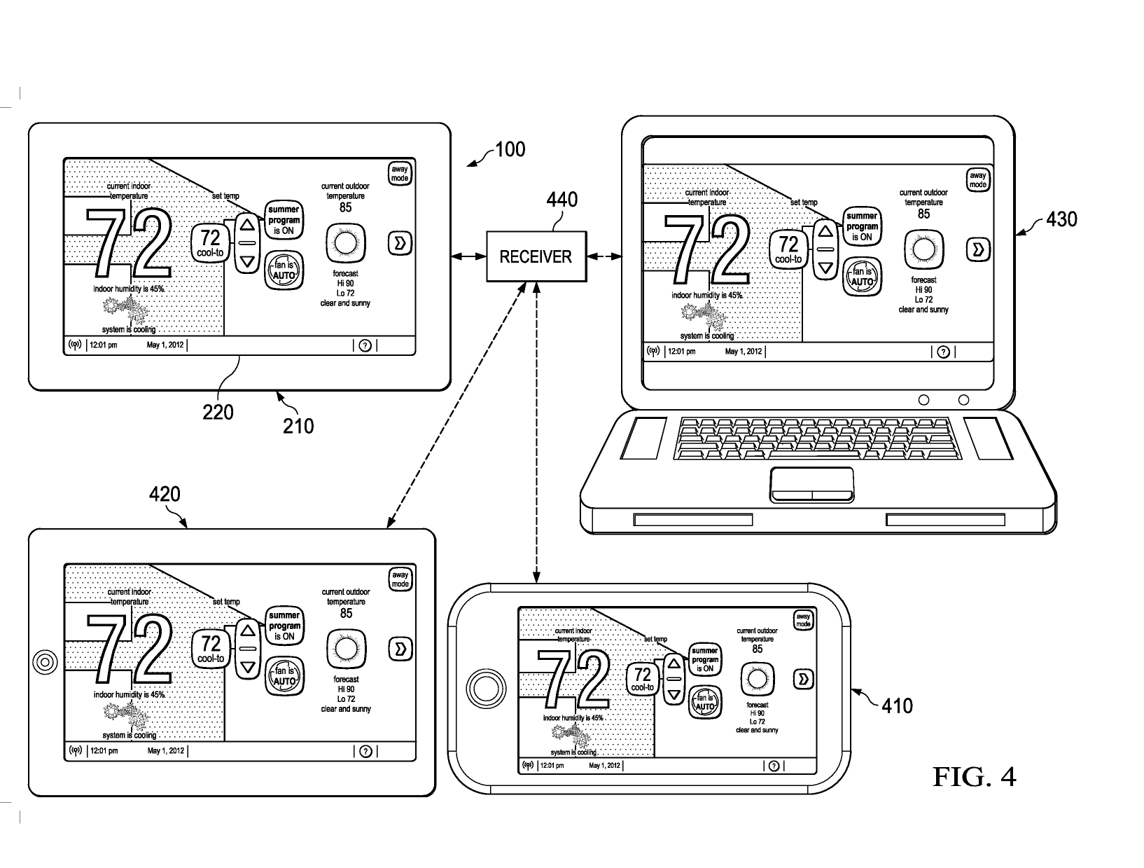

FIG. 4 is a representation of one embodiment of a screen of the user interface of FIG. 2 having one embodiment of a remote platform access application associated therewith; and

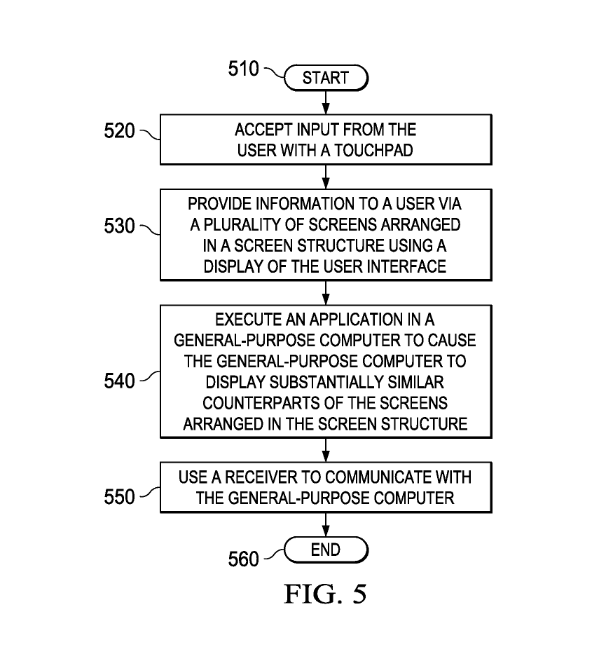

FIG. 5 is a flow diagram of one embodiment of a method of communicating with an HVAC system.

### DETAILED DESCRIPTION

FIG. 1 is a block diagram of one embodiment of a user interface 100. The interface has a display 110 and a touchpad 120. The display 110 is configured to provide information to a user, and the touchpad 120 is configured to accept input from a user. A processor and memory 130 are coupled to the display 110 and the touchpad 120 to drive the display 110 and process the input from the touchpad 120. More accurately, software or firmware is loaded into and stored in the memory and, when executed in the processor, configures the processor to drive the display 110 and process the input from the touchpad 120. An HVAC system interface 140 is coupled to the processor and memory 130 and is configured to provide communication between the processor and memory 130 and the remainder of an HVAC system 150. In various embodiments, the HVAC system 150 includes one or more loops of pipe (one being shown and referenced as 151) containing a refrigerant. Each loop transports the refrigerant among a heat pump or a compressor 152 having at least one stage, at least one condenser coil 153, an expansion valve 154 and at least one evaporator coil 155. One or more fans (“blowers”) 156 cause outdoor air and indoor air to blow over the at least one condenser coil 153 and the at least one evaporator coil 155 to transfer heat to or from them. Those skilled in the pertinent art are familiar with conventional HVAC systems and generally understand the many embodiments and forms they may take.

FIG. 2 is a front-side elevational view of one embodiment of the user interface of FIG. 1. The user interface 100 has a bezel 210. The display 110 is configured to display at least one screen 220 of information for the benefit of a user (the term also including an installer or any other person interested in gaining information from the user interface 100).

Although unreferenced, the screen 220 shown in FIG. 2 includes a current temperature display portion, a setpoint temperature display portion, buttons to raise or lower the setpoint temperature, a system mode message display portion (i.e., “system is heating”) and a program status message display portion (i.e., “program is on”). The screen 220 also has current date and time display portions and allows a user to display other screens (via a “press for more” message).

Today's user interfaces are usually found mounted on a wall, perhaps with a short-range radio-frequency or infrared remote control. To date, some companies have developed Smartphone applications (typically called “apps” in the Smartphone vernacular) that provide some of the functions and features that user interfaces do. However, they do not have substantially the same look and feel as the user interfaces themselves. Some of the apps substantially alter one or more of the screens by adding, rearranging or omitting some of the information, one or more buttons or change the behavior of pop-up elements, such as menus. The screens that result are therefore not substantial counterparts. Other apps fail to replicate the screen structure. Consequently, a user must learn the look and feel of both the user interface and any app that provides remote access to the HVAC system.

Applications falling within the scope of the invention replicate the look and feel of the user interface on the wall by replicating its screen structure and displaying substantial counterparts of its screens (substantially replicating the behavior of the elements of the screens as well) on a Smartphone, tablet or other general-purpose computing platform. Consequently, the application causes the Smartphone, tablet or other general-purpose computing platform to operate substantially like the user interface. In some embodiments, the application contains the same software code that executes in the user interface itself.

For purposes of this discussion, a “Smartphone” is regarded as being one type of general-purpose computer. Although Smartphones do perform telecommunication functions that are not typically in the domain of general-purpose computers, they also provide a general-purpose computing environment capable of hosting an app as described herein.

By replicating the look and feel of the user interface, the application can perform all substantial functions that the user interface does and thus provides a more uniform overall user experience and greater convenience. Such an application also makes setup and installation easier for installers. It can also benefit service and maintenance technicians, because they will be able set up the HVAC system not only via the wall-mounted user interface, but also remotely or wirelessly, without having to learn a different screen structure or screens. The application (executing as it does on the Smartphone, tablet or other general-purpose computer platform) replicates the entire “look and feel” of the user interface, and is not just a conventional application that alters some functions or the substantial look, feel and behavior of the user interface.

FIG. 3 is a block diagram of one example of a screen structure that interrelating example screens and is presented for the purpose of conveying what “screen structure” means in the context of this disclosure. FIG. 3 illustrates a plurality of example screens, namely a home screen 310, first and second configuration screens 320, 330, first, second, third, fourth and fifth operations screens 340, 350, 360, 370, 380 and a maintenance screen 390. In the example of FIG. 3, the home screen 310 is the screen that most often appears, and may be, for example, the screen 220 of FIG. 2. By pressing one or more buttons on the home screen, a user may cause the first configuration screen 320, the first operational screen 340, the fourth operational screen 370 or the maintenance screen 390 to be displayed. By pressing one or more buttons on the first configuration screen 320, the user may cause the second configuration screen 330 to be displayed or the home screen 310 to be redisplayed. By pressing on or more buttons on the second configuration screen 330, the user may cause the first configuration screen 320 or the home screen 310 to be redisplayed. Arrows interconnecting the home screen 310, the first and second configuration screens 320, 330, the first, second, third, fourth and fifth operations screens 340, 350, 360, 370, 380 and the maintenance screen 390 indicate the screen structure, namely the ways in which a user may navigate the example screens 310-390 and therefore how the example screens 310-390 are associated with one another. Those skilled in the pertinent art will be aware that any screen structure encompassing any number or arrangement of screens falls within the scope of the invention. Those skilled in the pertinent art will also understand that the example screens 310-390 need not be wholly distinct from one another but may be formed by causing one or more menus to “pop up” and overlie portions of a screen.

FIG. 4 is a representation, at a high level, of one embodiment of a screen of the user interface 100 of FIG. 2 having one embodiment of a remote platform access application associated therewith. In the embodiment of FIG. 4, the user interface 100 has counterparts in one or both of a Smartphone 410 (e.g., a commercially available iPhone® or Android®), a tablet 420 (e.g., a commercially available iPad®) and a laptop personal computer (PC) 430. The counterparts cause the Smartphone 410, the tablet 420 and the laptop PC 430 to display substantially the same screens (having substantially the same arrangement of information, buttons, menus and button and menu behavior). The counterparts communicate wirelessly (e.g., through the Internet, perhaps in conjunction with a telecommunications network) with the HVAC system to convey information to the user and commands to the HVAC system. Accordingly, the HVAC system includes a receiver 440, which may be a wireless receiver or a wireline receiver. In one embodiment, the wireline receiver is coupled to the Internet. In the embodiment of FIG. 4, the receiver 440 is located in the user interface 100. In an alternative embodiment, the receiver 440 is located outside of the user interface 100, perhaps instead located in an indoor unit of the HVAC system.

As stated above, the substantial contents of the user interface 100, including all functionality, are embodied in an application executing on a Smartphone, tablet or other general-purpose computing or telecommunication platform. This includes home screen functions, buttons, menus and behaviors; programming screen functions, buttons, menus and behaviors; configuration screen functions, buttons, menus and behaviors; maintenance screen functions, buttons, menus and behaviors; installation screen functions, buttons, menus and behaviors; all other screens functions, buttons, menus and behaviors; and the screen structure of the user interface 100.

As stated above, a counterpart, embodied as an application (e.g., an “app”), may contain the same software code that executes in the user interface 100 itself. Some of these embodiments simply execute the same software code. Other of these embodiments employ an emulator that allows the user interface software code to execute in the environment of the Smartphone, tablet or other general-purpose computer or telecommunications device. Accordingly, the emulator is configured to recognize and execute the instructions (e.g., opcodes) in the software code and provide data to, and receive data from, the software code to effect the functionality for which it was written. Those skilled in the art are familiar with the structure and function of emulators and their ability to appear as a native environment to an application written for that environment while, at the same time, appear to a device as a native application written for that device.

In alternative embodiments, some or all of the software code may be adapted for execution in the Smartphone, tablet or other general-purpose computer or telecommunications device. Such adapting may be carried out by adding or modifying a hardware adaptation layer of the software code. Those skilled in the pertinent art are familiar with adaptation layers, which perform a translation function between an application and an underlying operating system. Such adapting may alternatively be carried out by means of adapting the software code itself, either manually or automatically by means of special translation software in a process colloquially known as “porting.”

FIG. 5 is a flow diagram of one embodiment of a method of communicating with an HVAC system. The method begins in a start step 510. In a step 520, input is accepted from a user with a user interface having a touchpad. In a step 530, information is provided to the user via a plurality of screens arranged in a screen structure using a display of the user interface. In a step 540, an application is executed in a general-purpose computer to cause the general-purpose computer to display substantially similar counterparts of the screens arranged in the screen structure. In a step 550, a receiver is used to communicate with the general-purpose computer. The method ends in an end step 560.

Those skilled in the art to which this application relates will appreciate that other and further additions, deletions, substitutions and modifications may be made to the described embodiments.

1. An HVAC system, comprising:
a user interface configured to accept input from a user and a display configured to provide information to said user via a plurality of screens arranged in a screen structure;
an application executable on a general-purpose computer and configured to cause said general-purpose computer to display substantially similar counterparts of said screens arranged in said screen structure; and
a receiver configured to communicate with said general-purpose computer.

2. The HVAC system as recited in claim 1 wherein said receiver is selected from the group consisting of:
a wireless receiver, and
a wireline receiver.

3. The HVAC system as recited in claim 1 wherein said application contains the same software code that executes in said user interface.

4. The HVAC system as recited in claim 3 wherein an emulator executing on said general-purpose computer is configured to allow said software code to execute therein.

5. The HVAC system as recited in claim 1 wherein said general-purpose computer is selected from the group consisting of:
a Smartphone,
a tablet, and
a personal computer.

6. The HVAC system as recited in claim 1 wherein said user interface is a thermostat.

7. A method of communicating with an HVAC system, comprising:
accepting input from a user with a user interface having a touchpad;
providing information to said user via a plurality of screens arranged in a screen structure using a display of said user interface;
executing an application in a general-purpose computer to cause said general-purpose computer to display substantially similar counterparts of said screens arranged in said screen structure; and
using a receiver to communicate with said general-purpose computer.

8. The method as recited in claim 7 wherein said receiver is selected from the group consisting of:
a wireless receiver, and
a wireline receiver.

9. The method as recited in claim 7 wherein said application contains the same software code that executes in said user interface.

10. The method as recited in claim 9 further comprising employing an emulator executing on said general-purpose computer to allow said software code to execute therein.

11. The method as recited in claim 7 wherein said general-purpose computer is selected from the group consisting of:
a Smartphone,
a tablet, and
a personal computer.

12. The method as recited in claim 7 wherein said user interface is a thermostat.

13. An HVAC system, comprising:
a heat pump or a compressor having at least one stage;
at least one condenser coil;
an expansion valve;
at least one evaporator coil;
a loop of pipe interconnecting said heat pump or compressor, said at least one condenser coil, said expansion valve and said at least one evaporator coil and containing a refrigerant;
at least one fan configured to cause outdoor air and indoor air to blow over said at least one condenser coil and said least one evaporator coil;
a user interface having a touchpad configured to accept input from a user and a display configured to provide information to said user via a plurality of screens arranged in a screen structure;
an application executable on a general-purpose computer and configured to cause said general-purpose computer to display substantially similar counterparts of said screens arranged in said screen structure; and
a receiver configured to communicate with said general-purpose computer.

14. The HVAC system as recited in claim 13 wherein said receiver is selected from the group consisting of:
a wireless receiver, and
a wireline receiver.

15. The HVAC system as recited in claim 13 wherein said application contains the same software code that executes in said user interface.

16. The HVAC system as recited in claim 15 wherein an emulator executing on said general-purpose computer is configured to allow said software code to execute therein.

17. The HVAC system as recited in claim 13 wherein said general-purpose computer is selected from the group consisting of:
a Smartphone,
a tablet, and
a personal computer.

18. The HVAC system as recited in claim 13 wherein said user interface is a thermostat.
